(19) United States
(12) Patent Application Publication
(10) Pub. No.: US 2006/0217508 A1
(43) Pub. Date: Sep. 28, 2006

(54) Spray polymerization method

(75) Inventors: Markus Schmid, Deidesheim (DE); Volker Seidl, Mannheim (DE); Dieter Distler, Bietigheim-Bissingen (DE); Hans-Joachim Hahnle, Neustadt (DE); Dennis Losch, Limburgerhof (DE); Hans-Ulrich Moritz, Bendestorf (DE); Marco Kruger, Mannheim (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 10/568,208

(22) PCT Filed: Jul. 15, 2004
(86) PCT No.: PCT/EP04/07860

§ 371 Date: Feb. 13, 2006

(30) Foreign Application Priority Data
Aug. 29, 2003 (DE) 103 40 253.5

(51) Int. Cl. C08F 20/06

(52) U.S. Cl. 526/317.1; 526/319

(57) ABSTRACT

Aqueous monomer solutions comprising free-radically polymerizable monomers and at least 55% by weight of water are spray polymerized to prepare crosslinked, water-swellable polymers.

The present invention relates to an improved process for spray polymerization of free-radically polymerizable monomers.

Crosslinked water-swellable polymers also known as hydrogels or as superabsorbents, are capable of absorbing a multiple of their own weight of aqueous fluids. They are widely used in hygiene articles, such as diapers, sanitary napkins and the like. They contain polymerized units of water-insoluble ethylenically unsaturated monomers, such as carboxylic acids, amides and the like. Water-insoluble polymers are obtained through incorporation of crosslinking sites in the polymer. The degree of crosslinking determines not only the water solubility of the polymers but also their absorption capacity.

A further criterion of water-swellable polymers is their extractables content. Extractables are washed off when water-swellable addition polymers come into contact with body fluids, which reduces absorption capacity.

The EP-A-0 348 180 patent application describes a process for spray polymerization of water-absorptive resins. In this process, an aqueous solution of partially neutralized acrylic acid, crosslinker and initiator is atomized into a gas stream and polymerized. The reference teaches that the gas stream must have a relative humidity of at least 30%. At lower relative humidities, the water present in the droplets would evaporate too quickly and monomer would precipitate in the droplets and would no longer be available for polymerization, leaving monomer conversion incomplete. A disadvantage with this process is the need for product removal in a thoroughly insulated or trace-heated container (otherwise water vapor would condense on the product).

U.S. Pat. No. 5,269,980 describes a process for producing polymer particles. In this process, aerosols are generated from polymer solutions, solutions of prepolymerized monomers or monomer solutions and these aerosol particles are dried/polymerized at temperatures above 150° C. Polymerized aerosol particles are too small for use as a water-absorbing resin.

In the WO 96/40427 patent application, spray polymerization is conducted by atomizing monomer solutions into a hot, essentially static atmosphere. At reduced pressure, the water content of the polymeric spheres produced is distinctly down, but the polymer particles have a rough surface. At elevated pressure, smooth polymeric spheres are obtained.

The desired low residual water content should be achieved without further operations, for example drying. For this reason, a low water content of below 30% by weight was chosen for the monomer solutions.

The EP-A-0 816 383 patent application teaches the production of hydrophilic, highly swellable hydrogels in a fluidized bed apparatus. The polymer particles generated by the process described in the reference are from 0.1 to 2 mm in diameter and have an onion skin structure, i.e., an existing polymer grain is sprayed with further monomer solution which then polymerizes. This also gives larger polymer particles than the aforementioned processes.

The present invention has as its object to provide an improved spray polymerization process for producing crosslinked, water-swellable polymers.

It has now been found that crosslinked, water-swellable polymers which have improved properties with regard to absorbency and extractables are obtained on spray polymerization of a monomer solution having a water content of at least 55% by weight in an inert atmosphere.

The water content is preferably in the range from 60 to 95% by weight, more preferably in the range from 65 to 90% by weight and especially in the range from 70 to 85% by weight.

The monomer solutions which can be used in the invented process contain for example at least a) a free-radically polymerizable monomer, b) a crosslinker, c) a polymerization initiator and d) water.

Free-radically polymerizable monomers a) are for example ethylenically unsaturated C₃-C₆-carboxylic acids, their amides and esters with amino alcohols of the formula I 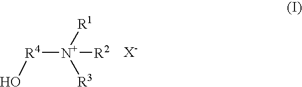
where R⁴ is C₂-C₅-alkylene and R¹, R², R³ are independently hydrogen, methyl, ethyl, or propyl. Examples of these compounds are acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid and also the alkali metal or ammonium salts of these acids, acrylamide, methacrylamide, crotonamide, dimethylaminoethyl methacrylate, dimethylaminoethyl acrylate, dimethyl-aminopropyl acrylate, diethylaminopropyl acrylate, dimethylaminobutyl acrylate, di-methylaminoethyl methacrylate, diethylaminoethyl methacrylate, dimethylaminoneopentyl acrylate and dimethylaminoneopentyl methacrylate. The basic acrylates and methacrylates are used in the form of salts with strong mineral acids, sulfonic acids or carboxylic acids or in quaternized form. The X⁻ anion in the compounds of the formula (I) is the mineral or carboxylic acid residue or methosulfate, ethosulfate or halide from a quaternizing agent.

Further free-radically polymerizable monomers a) are N-vinylpyrrolidone, acrylamidopropanesulfonic acid, vinylphosphonic acid and/or alkali metal or ammonium salts of vinylsulfonic acid. The other acids can likewise be used in the polymerization either in unneutralized form or in partially or 100% neutralized form. Useful free-radically polymerizable monomers further include N-vinylimidazolium compounds, such as salts or quaternization products of N-vinylimidazole and 1-vinyl-2-methylimidazole, and N-vinylimidazolines, such as N-vinylimidazoline, 1-vinyl-2-methylimidazoline, 1-vinyl-2-ethylimidazoline or 1-vinyl-2-n-propylimidazoline, which are all likewise used in the polymerization in quaternized form or as a salt.

Further monoethylenically unsaturated sulfonic or phosphonic acids are likewise suitable, for example allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloylypropylsulfonic acid, allylphosphonic acid, styrenesulfonic acid and 2-acrylamido-2-methylpropanesulfonic acid. The monomers a) can be used alone or admixed with each other.

Preferred monomers a) are acrylic acid, methacrylic acid and also the alkali metal or ammonium salts of these acids, acrylamide and/or methacrylamide, further vinylsulfonic acid, acrylamidopropanesulfonic acid or mixtures of these acids, for example mixtures of acrylic acid and methacrylic acid, mixtures of acrylic acid and acrylamidopropanesulfonic acid or mixtures of acrylic acid and vinylsulfonic acid. These monomers can be copolymerized with each other in any desired ratio.

Preferred monomers a) further include mixtures of the abovementioned acids with their alkali metal or ammonium salts. For example, mixtures of acrylic acid and its alkali metal salts are obtainable by neutralization of acrylic acid with alkali metal hydroxides and/or alkali metal carbonates. The degree of neutralization is preferably at least 40% and more preferably in the range from 60 to 90%. In this connection, a 50% degree of neutralization, for example from a mixture of acrylic acid and sodium acrylate, means that sodium acrylate and acrylic acid are present in a molar ratio of 50:50, while a 75% degree of neutralization means that sodium acrylate and acrylic acid are present in a molar ratio of 75:25.

Very particularly preferred monomers a) are acrylic acid, methacrylic acid, the potassium salts of these acids and also mixtures thereof, for example mixtures of acrylic acid and potassium acrylate.

The polymerization of the monomers a) takes place in the presence of one crosslinker b) or a combination of various crosslinkers.

Suitable crosslinkers b) are for example (meth)acrylic esters of polyhydric alcohols which may have been alkoxylated with up to 100 and usually up to 50 ethylene oxide and/or propylene oxide units. Suitable polyhydric alcohols are in particular C₂-C₁₀-alkanepolyols having 2 to 6 hydroxyl groups, such as ethylene glycol, glycerol, trimethylolpropane, pentaerythritol or sorbitol. Preferred crosslinkers are polyethylene glycol diacrylate and polyethylene glycol dimethacrylates, which are each derived from polyethylene glycols (which may be considered as ethoxylated ethylene glycol) having a molecular weight in the range from 200 to 2000. Further usable crosslinkers b) are trimethylolpropane triacrylate, trimethylolpropane trimethacrylate, ethylene glycol diacrylate, propylene glycol diacrylate, butanediol diacrylate, hexanediol diacrylate, hexanediol dimethacrylate or diacrylates and dimethacrylates of block copolymers formed from ethylene oxide and propylene oxide.

Useful crosslinkers b) further include diallyl carbonate, allyl carbonates or allyl ethers of polyhydric alcohols which may have been alkoxylated with up to 100, and usually up to 50 ethylene oxide and/or propylene oxide units, and allyl esters of polybasic carboxylic acids.

Allyl carbonates of polyhydric alcohols conform to the general formula II 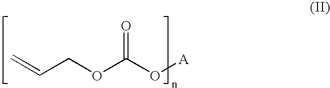
where A is the radical of a polyhydric alcohol which may have been alkoxylated with up to 100 and usually up to 50 ethylene oxide and/or propylene oxide units; and n represents the hydricness of the alcohol, for example an integer from 2 to 10 and preferably from 2 to 5. A particularly preferred example of such a compound is ethylene glycol di(allyl carbonate). Also suitable are particularly polyethylene glycol di(allyl carbonate)s which are derived from polyethylene glycols having a molecular weight in the range from 200 to 2000.

Preferred examples of allyl ethers are: polyethylene glycol diallyl ethers which are derived from polyethylene glycols having a molecular weight from 200 to 2000; pentaerythritol triallyl ether or trimethylolpropane diallyl ether. It is further possible to use reaction products of ethylene glycol diglycidyl ether or polyethylene glycol glycidyl ether with 2 mol of allyl alcohol and/or pentaerythritol triallyl ether.

An example of a suitable allyl ester with polybasic carboxylic acid is diallyl phthalate.

The monomers are generally copolymerized with each other in at most 45%, preferably from 5 to 40%, more preferably from 10 to 35% and especially from 15 to 30% by weight aqueous solution in the presence of polymerization initiators c).

Useful polymerization initiators c) include all compounds which decompose into free radicals under the polymerization conditions, for example peroxides, hydroperoxides, hydrogen peroxide, persulfates, azo compounds and redox catalysts. Preference is given to using water-soluble initiators. In some cases it is advantageous to use mixtures of various polymerization initiators, for example mixtures of hydrogen peroxide and sodium peroxodisulfate or potassium peroxodisulfate. Mixtures of hydrogen peroxide and sodium peroxodisulfate may be used in any proportion. Useful organic peroxides include for example acetylacetone peroxide, methyl ethyl ketone peroxide, tert-butyl hydroperoxide, cumene hydroperoxide, tert-amyl perpivalate, tert-butyl perpivalate, tert-butyl perneohexan oate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl peresters, cumyl peroxyneodecanoate, tert-butyl per-3,5,5-tri-methylhexanoate, acetylcyclohexylsulfonyl peroxide, dilauryl peroxide, dibenzoyl peroxide and tert-amyl perneodecanoate. Useful polymerization initiators c) further include water-soluble azo initiators, for example 2,2′-azobis(2-amidinopropane) dihydrochloride, 2-(carbamoylazo)isobutyronitrile, 2,2′-azobis-[2-(2′imidazolin-2-yl)propane] dihydrochloride and 4,4′-azobis-(4-cyanovaleric acid). The polymerization initiators c) mentioned are used in customary amounts, for example in amounts from 0.01 to 5%, preferably from 0.05 to 2.0%, by weight, based on the monomers to be polymerized.

Useful initiators c) further include redox catalysts. In redox catalysts, the oxidizing component is at least one of the above-specified per compounds and the reducing component is for example ascorbic acid, glucose, sorbose, ammonium or alkali metal bisulfite, sulfite, thiosulfate, hyposulfite, pyrosulfite or sulfide, or metal salts, such as iron(II) ions or silver ions or sodium hydroxymethylsulfoxylate. The reducing component in the redox catalyst is preferably ascorbic acid or sodium pyrosulfite. Based on the amount of monomers used in the polymerization, from 1·10⁻⁵ to 1 mol % is used of the reducing component of the redox catalyst. Instead of the oxidizing component of the redox catalyst it is also possible to use one or more water-soluble azo initiators.

The process of the invention is preferably carried out using a redox system of hydrogen peroxide, sodium peroxodisulfate and ascorbic acid. In a customary embodiment, these components are used in the concentrations of 1·10⁻² mol % hydrogen peroxide, 0.084 mol % sodium peroxodisulfate and 2.5·10⁻³ mol % ascorbic acid based on the monomers.

The monomers used are preferably stabilized with a commercially available polymerization inhibitor and more preferably with a polymerization inhibitor which only acts together with oxygen, an example being hydroquinone monomethyl ether.

Commercially available polymerization inhibitors are polymerization inhibitors which are used as storage stabilizers in the respective monomers for product safety reasons. Examples of such storage stabilizers are hydroquinone, hydroquinone monomethyl ether, 2,5-di-tert-butylhydroquinone and 2,6-di-tert-butyl-4-methylphenol.

The reaction is preferably carried out in apparatuses which are also suitable for spray drying. Such reactors are described for example in K. Masters, Spray Drying Handbook, 5th Edition, Longman, 1991, pages 23 to 66.

The reaction is preferably carried out in apparatuses in which the monomer solution can free-fall in the form of monodisperse droplets. Suitable for this purpose are apparatuses as described for example in the U.S. Pat. No. 5,269,980 patent.

The droplet diameter resulting in the course of spraying is in the invention advantageously in the range from 50 to 1000 μm and preferably in the range from 100 to 600 μm.

The reaction can be carried out in overpressure and in underpressure, preferably preference being given to the reaction pressure which results when the offgas system is open to the atmosphere.

The reactor is purged by a stream of an inert gas and preferably nitrogen flowing through it. A cocurrent operation is preferred; that is, the inert gas flows downwardly through the reactor. The water vapor content of the inert gas is generally up to 1% by volume and preferably up to 0.5% by volume. The inert gas velocity is preferably adjusted such that the flow in the reactor is laminar and is for example in the range from 0.02 to 1.5 m/s and preferably in the range from 0.05 to 0.4 m/s.

The inert gas is advantageously preheated to the reaction temperature of 90 to 300° C. and preferably 150 to 210° C. upstream of the reactor.

The reaction offgas can be cooled down in a heat exchanger for example. Water and unconverted acrylic acid condense in the process. Thereafter, the offgas can be at least partially reheated and returned into the reactor as recycle gas. Preferably, the offgas is cooled such that the cooled offgas has the water vapor fraction desired for the reaction. A portion of the offgas can be removed from the system and replaced with fresh inert gas.

Particular preference is given to an energy-integrated system whereby a portion of the heat rejected in the cooling of the offgas is used to heat up the recycle gas.

The reactors are preferably trace heated. Trace heating is preferably adjusted such that the wall temperature is at least 5° C. above reactor internal temperature and condensation at reactor walls is largely avoided.

The reaction product can be removed from the reactor in a conventional manner, preferably at the base via a conveying screw, and optionally be dried to the desired residual moisture content and to the desired residual monomer content.

The invented process gives water-swellable polymers having high absorbancy and low extractables.

### EXAMPLES

Parts are by weight unless otherwise stated. The dried hydrogel was tested using the following test methods standardized by the European Disposables and Nonwovens Association (Edana):

Centrifuge Retention Capacity (CRC):
Edana recommended test methods no. 441.2-02

Extractables:
Edana recommended test methods no. 470.2-02

### Examples 1 To 8

An aqueous monomer solution consisting of partially neutralized acrylic acid and methylenebisdiacrylamide crosslinker was mixed with a 1.0% by weight aqueous solution of 2,2′-azobis-2-amidinopropane dihydrochloride initiator immediately upstream of the reactor.

The crosslinker quantity was 0.3% by weight, based on monomer used. The initiator quantity was 0.11% by weight, based on monomer solution used. The degree of neutralization of the acrylic acid used was 75 mol %.

The reactor used was a vertically suspended tube of special steel 2,600 mm in length and 164 mm in diameter. Temperature was adjustable via three independent heating circuits. A glass tube 102 mm in diameter had been pushed into the steel tube from the top. A modified SBG-2000 vibrating orifice aerosol generator from Palas GmbH of Karlsruhe had been placed on the glass tube. The vibrating orifice was 75 μm in diameter. The vibrating orifice aerosol generator was used to meter 0.4 l/min of nitrogen and 1.0 ml/min of monomer solution in the reactor. In addition, 10 l/min of nitrogen preheated to reaction temperature was metered into the interspace between steel tube and glass tube. The interspace was packed with Raschig rings and open at the downward end for the nitrogen. The Raschig rings served as flow straighteners.

The product was collected at the bottom end of the reactor, dried at 125° C. for 1 h and analyzed. Relative values are reported, based on the comparative example.

TABLE 1
Spray polymerization of sodium/potassium acrylate

| | Water content of | | | | |
|---|---|---|---|---|---|
| | monomer solution | | Temp. | Rel. | Rel. |
| Ex. | [wt. %] | Na/K acrylate | [° C.] | CRC | extractables |
| 1* | 50.0 | K acrylate | 154 | 1.00 | 1.00 |
| 2 | 60.0 | K acrylate | 154 | 1.13 | 0.78 |
| 3 | 70.0 | K acrylate | 157 | 1.65 | 0.32 |
| 4 | 58.9 | Na acrylate | 153 | 1.03 | 1.11 |
| 5 | 65.0 | Na acrylate | 159 | 1.15 | 0.95 |
| 6 | 70.0 | Na acrylate | 155 | 1.46 | 0.79 |

*comparative example

1. The A process for spray polymerization in an inert atmosphere of a monomer solution comprising free-radically polymerizable monomers wherein a water content of the monomer solution is in the range from 60% to 95% by weight and a reaction temperature is in a range from 90 to 300° C.

2. The process of claim 1 wherein the water content of the monomer solution is at least 65% by weight.

3. The process of claim 1 wherein the water content of the monomer solution is at least 70% by weight.

4. The process of claim 1 wherein the reaction temperature is in the range from 150 to 210° C.

5. The process of claim 1 wherein the free-radically polymerizable monomer is acrylic acid, methacrylic acid, or a mixture thereof.

6. The process of claim 5 wherein the acrylic acid, methacrylic acid, or mixture thereof is at least 40% neutralized.

7. The process of claim 1 wherein the free-radically polymerizable monomer is a mixture of acrylic acid and potassium acrylate.

8. A water-swellable polymer prepared by the process of claim 1.

9. The process claim 2 wherein the reaction temperature is in the range from 150 to 210° C.

10. The process of claim 3 wherein the reaction temperature is in the range from 150 to 210° C.

11. The process of claim 2 wherein the free-radically polymerizable monomer is acrylic acid, methacrylic acid, or a mixture thereof.

12. The process of claim 11 wherein the acrylic acid, methacrylic acid, or mixture thereof is at least 40% neutralized.

13. The process of claim 3 wherein the free-radically polymerizable monomer is acrylic acid methacrylic acid, or a mixture thereof.

14. The process of claim 13 wherein the acrylic acid, methacrylic acid, or mixture thereof is at least 40% neutralized.

15. The process of claim 4 wherein the free-radically polymerizable monomer is acrylic acid, methacrylic acid, or a mixture thereof.

16. The process of claim 15 wherein the acrylic acid, methacrylic acid, or mixture thereof is at least 40% neutralized.

17. The process of claim 2 wherein the free-radically polymerizable monomer is a mixture of acrylic acid and potassium acrylate.

18. The process of claim 3 wherein the free-radically polymerizable monomer is a mixture of acrylic acid and potassium acrylate.

19. The process of claim 4 wherein the free-radically polymerizable monomer is a mixture of acrylic acid and potassium acrylate.

20. The water-swellable polymer of claim 8 wherein the free-radically polymerized monomer is acrylic acid, methacrylic acid, or a mixture there-of.
